(19) United States
(12) Patent Application Publication
(10) Pub. No.: US 2021/0334889 A1
(43) Pub. Date: Oct. 28, 2021

(54) SHOPPING SYSTEM

(71) Applicant: Charles Isgar, Scottsdale, AZ (US)

(72) Inventor: Charles Isgar, Scottsdale, AZ (US)

(21) Appl. No.: 17/201,829

(22) Filed: Mar. 15, 2021

Related U.S. Application Data
(60) Provisional application No. 63/014,953, filed on Apr. 24, 2020.

(51) Int. Cl. G06Q 30/06; H04N 7/18

(52) U.S. Cl. CPC G06Q 30/0643; H04N 7/185; G06Q 30/0639; G06Q 30/0633

(57) ABSTRACT

Described is a shopping system. The system includes a server having a memory storing store information, including at least one shopping video or photography of travel up and down aisles of a store recorded by a camera system. The system also includes a shopper computing device and a user computing device, each coupled to the server. The system allows a customer to virtually navigate and shop in a store through the user computing device accessing the system and the stored shopping video or photography. The customer may select items and the system may apply a location tag to the location of the selected item within the store. Once an order is completed, a fulfillment shopper may then utilize the shopper computing device to receive a list of selected items and a map showing location of the items within the store that may display the most efficient route for fulfillment.

### CROSS REFERENCE TO RELATED APPLICATION[S]

This application claims priority to U.S. Provisional Patent Application entitled “Shopping System,” Ser. No. 63/014,953, filed Apr. 24, 2020, the disclosure of which is hereby incorporated entirely herein by reference.

### BACKGROUND OF THE INVENTION

### Technical Field

This invention generally relates to a system for virtual shopping, and more specifically to a shopping system for providing current video or photography images to a customer to navigate through a physical store and select items actually stocked on shelves for placement in a virtual cart and then provide a shopping list of items from the customer to a fulfillment shopper, including location of the shopping list items within the physical store to improve efficiency of a shopping service in locating the items on the shopping list within the store chosen by the customer.

### State of the Art

Online shopping is becoming more commonplace for all types of products, including groceries and other personal care and cleaning items, particularly, when a consumer does not or is not able to actually go to his or her favorite store. Further, services exist where individuals are employed to travel to a store with a list of items for a particular customer from a particular store or multiple stores for pick-up, purchase and delivery to a home of the customer. Existing online shopping systems lack the ability to provide an in-store shopping experience as if the customer was shopping the aisles themselves. Further still, existing online shopping systems may not provide accurate or up-to-date inventory of certain products. Also, many shopping services have inefficiencies matching an online list when they go to fulfil the order at the physical location that they are unfamiliar with.

Accordingly, what is needed is an improved remote virtual shopping system that allows for a remote shopping experience that is similar to an in-person shopping experience and provides location information of the items ordered by the customer to a fulfillment shopper in order to make fulfillment more efficient.

### SUMMARY OF THE INVENTION

An embodiment includes a shopping system comprising: a server having a memory storing store information, including at least one shopping video or photography of travel up and down aisles of a store recorded by a camera system; a shopper computing device coupled to the server; and a user computing device coupled to the server, wherein the server is programmed to: receive and process a signal from the camera system containing recorded shopping video or photography of travel up and down aisles of the store and store the shopping video or photography in the memory of the server; receive and process a signal from the user computing device that the user computing device has accessed the system and requested to shop at the store; send, for display on the user computing device, a shopping interface including the shopping video or photography with navigation controls; receive navigation input from the navigation controls on the shopping interface displayed on the user computing device and adjust the display in response to the input from the navigation controls; receive item selection inputs from the user computing device, store the selection inputs as selected items in a shopping list, automatically apply a location tag to each selected item, and store each location tag of each selected item within the store; receive a signal from the user computing device that the items in the shopping list are ready for fulfillment; receive and process a signal from the shopper computing device that the shopper computing device has accessed the system and is available to fulfill the shopping list input by the user computing device; send, for display on the shopper computing device, a shopper interface including the shopping list and location of each item of the shopping list within the store.

The store information may comprise store maps. The store maps may be associated with the at least one shopping video or photography. The shopper computing device may be a mobile computing device. The user computing device may be a mobile computing device. A communication interface may be displayed on the user computing device for communication with the shopper computing device through voice chat, text chat, and/or video chat. The camera system may be a mobile system. The camera system may comprise a cart. The cart may be navigated up and down the aisles. The cart may comprise one or more mobile cameras. The one or more mobile cameras are mounted to the cart such that the one or more mobile cameras are at shelf levels to record each shelf of the aisles. The at least one shopping video or photography identifies what SKUs are located on what shelf. A shopper camera may be in communication with the shopper computing device. The shopper camera may stream a shopping trip through the store to the user computing device. The at least one shopping video or photography may be updated at predetermined times. The at least one shopping video or photography may be updated at daily. The shopping system may comprise more than one of the shopper computing device. The shopping system may comprise more than one of the user computing device.

The foregoing and other features and advantages of the invention will be apparent to those of ordinary skill in the art from the following more particular description of the invention and the accompanying drawings.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 is a diagrammatic view of a shopping system according to an embodiment;

FIG. 2 is a perspective view of a camera system operating as part of a shopping system according to an embodiment;

FIG. 3 is a user interface for interaction with a shopping system according to an embodiment;

FIG. 4A is a user interface for interaction with a shopping system according to an embodiment;

FIG. 4B is a user interface for interaction with a shopping system according to an embodiment;

FIG. 4C is a user interface for interaction with a shopping system according to an embodiment;

FIG. 4D is a user interface for interaction with a shopping system according to an embodiment;

FIG. 5A is a shopper interface for interaction with a shopping system according to an embodiment;

FIG. 5B is a shopper interface for interaction with a shopping system according to an embodiment;

FIG. 5C is a shopper interface for interaction with a shopping system according to an embodiment;

FIG. 6 is a shopper interface for interaction with a shopping system according to an embodiment;

FIG. 7 is a perspective view of a fulfillment shopping cart in a store using a shopping system and lighting a location of items according to an embodiment;

FIG. 8 is a perspective view of a fulfillment shopping cart in a store using a shopping system and lighting a location of items according to an embodiment;

FIG. 9 is a user interface for interaction with a shopping system according to an embodiment;

FIG. 10 is a perspective view of a fulfillment shopper wearing a body camera during fulfillment of a virtual remote order according to an embodiment.

### DETAILED DESCRIPTION OF EMBODIMENTS OF THE INVENTION

Embodiments of the present invention relate to a shopping system for providing current video or photography images to a remote customer to navigate through a store and select items on shelves for placement in a virtual cart and then provide a shopping list of items from the customer to a fulfillment shopper, including location of the shopping list items within the store to improve efficiency of locating the items in the shopping list within the store chosen by the customer. Modern technology utilized by the system operates as a shopping system. The system may include the use of a mobile application operating on a user computing device and on a shopper computing device that may be a mobile computing device like a smartphone, a tablet, a wearable, and the like; and/or the system may operate on any type of computing device, including a computer or the like.

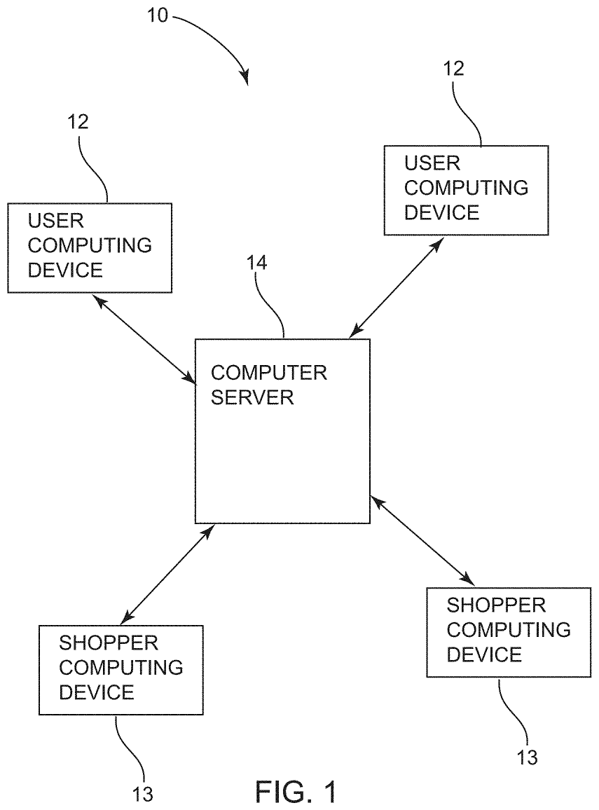

FIG. 1 depicts an embodiment of a shopping system 10. The system 10 may include user computing devices 12, a shopper computing device 13 and a computer server 14, wherein each user computing device 12 and shopper computing device 13 is coupled to the computer server 14. This coupling may be a network connection, such as a wireless connection through an Internet connection, a Wi-Fi connection, a Bluetooth connection or the like, wherein the user computing devices 12 and the shopper computing devices 13 may communicate with and receive communication from the server 14. The user computing device 12 may be any of a desktop computer, a laptop, a tablet, a smartphone, a wearable device and the like. The shopper computing device 13 may be any of a laptop, a tablet, a smartphone, a wearable device and the like. The server 14, in some embodiments, may be a computer server or a cloud-based infrastructure architecture.

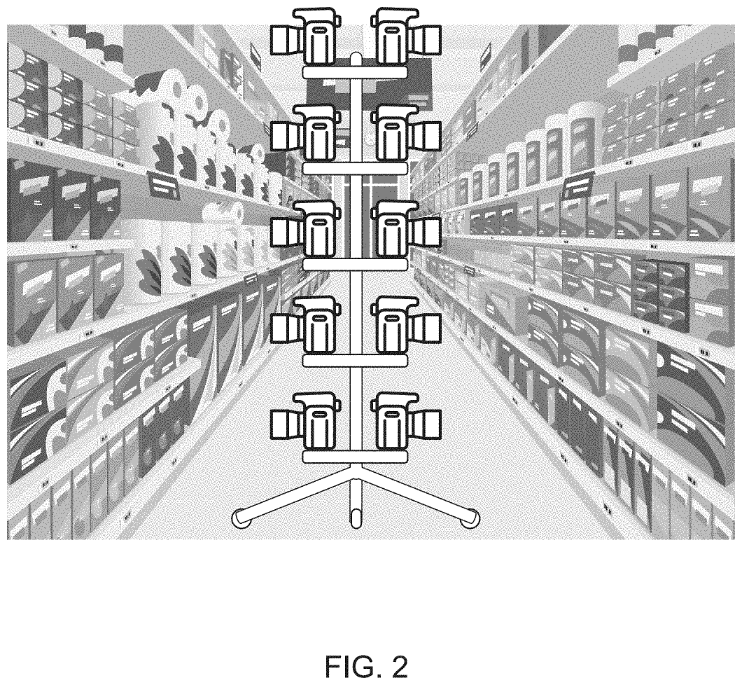

The server 14 may include a memory storing store information. The store information may include at least one shopping video or photography of travel up and down aisles of a store recorded by a camera system as depicted in FIG. 2. For example, the camera system may be a mobile system, such as a cart that can hold one or more cameras. The cart may be navigated up and down aisles. In systems with more than one camera, the cameras may be mounted to the mobile cart in a way that places each camera at shelf levels to better record each shelf of each aisle. In embodiments, the server 14 may store shopping videos or photography of travel for a plurality of stores. Further, in some embodiments, store maps may be supplied to the server 14, wherein the shopping videos or photography may be associated with the store maps in order to identify what SKUs are located on what rows, thereby aligning shopping videos or photography of stores with corresponding store maps. The system 10 may also identify, from the shopping video or photography, what SKUs are located on what shelf by identifying the SKUs from the shelf tags. The server 14 may be programmed to make a selectable link for each shelf tag to allow a customer engaged in remote shopping from home or a like location to select items to put in a virtual shopping cart by selecting the shelf tag.

A user computing device 12 and a shopper computing device 13 may be coupled to the server 14, and the server 14 may be programmed to receive and process a signal from the camera system containing recorded shopping video or photography of travel up and down aisles of the store and store the shopping video or photography in the memory of the server; receive and process a signal from the user computing device that the user computing device has accessed the system and requested to shop at the store; send, for display on the user computing device, a shopping interface including the shopping video or photography with navigation controls; receive navigation input from the navigation controls on the shopping interface displayed on the user computing device and adjust the display in response to the input from the navigation controls; receive item selection inputs from the user computing device, store the selection inputs as selected items in a shopping list, automatically apply a location tag to each selected item, and store each location tag of each selected item within the store; receive a signal from the user computing device that the items in the shopping list are ready for fulfillment; receive and process a signal from the shopper computing device that the shopper computing device has accessed the system and is available to fulfill the shopping list input by the user computing device; send, for display on the shopper computing device, a shopper interface including the shopping list and location of each item of the shopping list within the store.

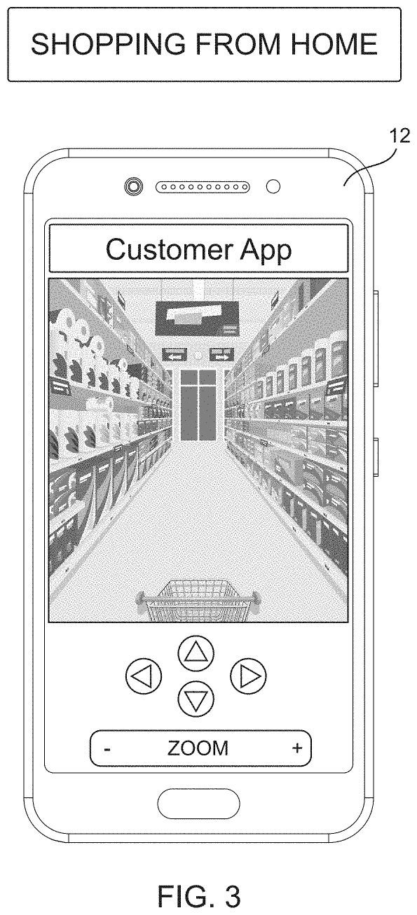

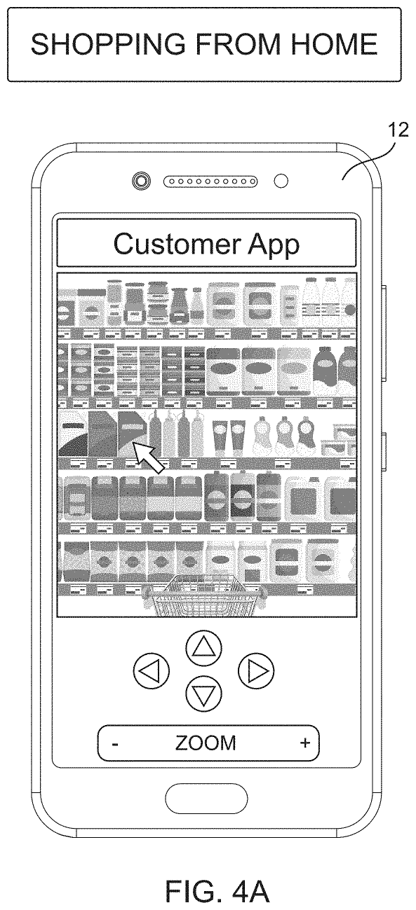

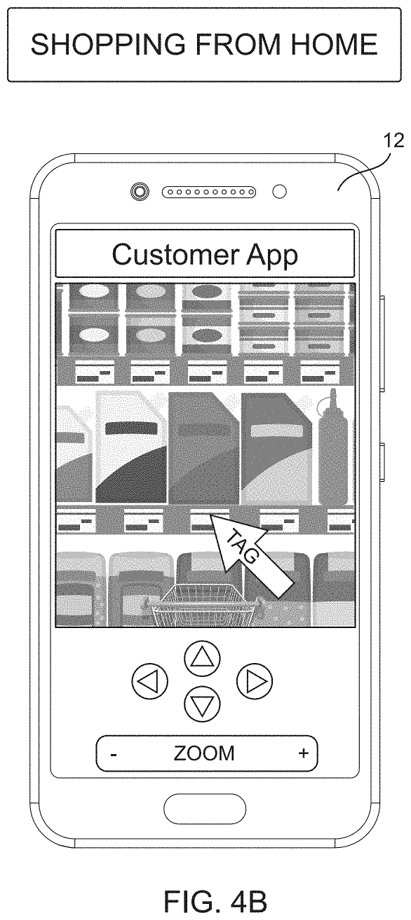

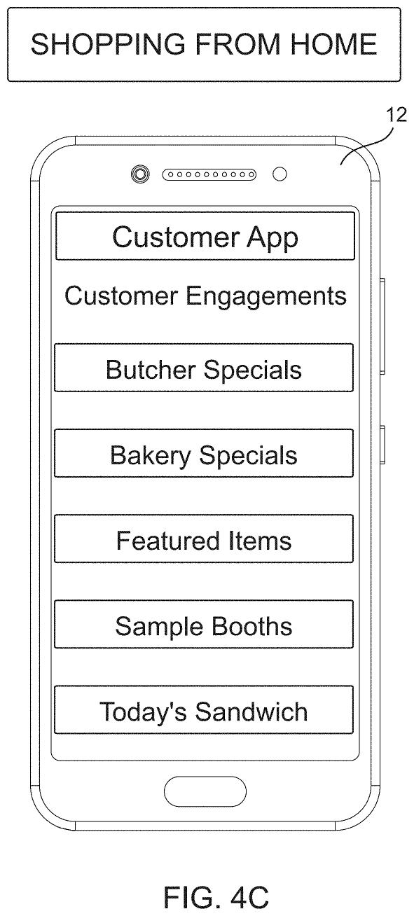

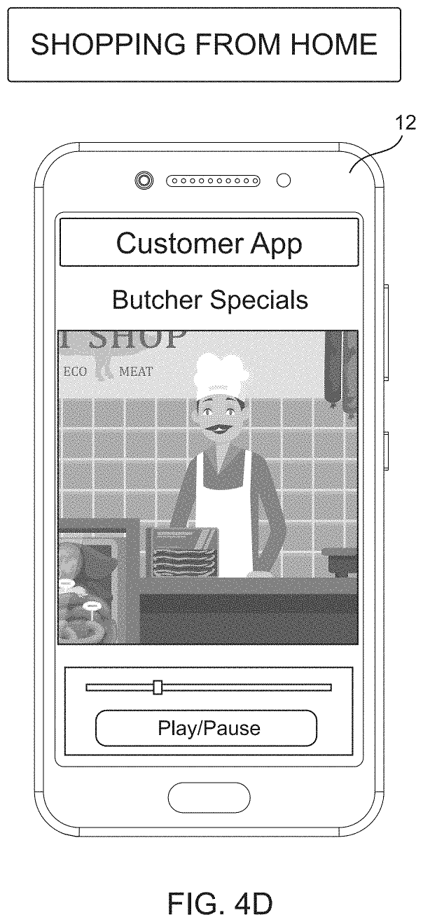

Referring to FIGS. 3-4D, the system 10 may then allow a user to access the system through the user computing device 12 to engage in remote virtual shopping from a store. When shopping from home or from another location remote from the store, the customer may utilize the user computing device 12 to access the system and the server 14 may be programmed to send for display a user interface that displays the stored video or photography images associated with the store the customer has selected for shopping. The user interface may include navigation controls that allow the customer to navigate up and down aisles, view products on shelves and zoom for a better view of the product and the like, as shown in FIG. 3. The customer may use the navigation control to face a particular section of shelving in a store as depicted in FIG. 4A. If desired, the customer may then zoom in for a closer view, using the zoom control as depicted in FIG. 4B. As discussed above, the server 14 may be programmed to make a selectable link for each shelf tag. The customer may select an item to put into his or her shopping cart in response to selecting the shelf tag of the item that is now a selectable link. Referring to FIG. 4B, when selection of an item to put in the shopping cart is executed by the customer using the user computing device 12, the server 14 may receive a signal that includes item selection inputs from the user computing device, store the selection inputs as selected items in a shopping list, automatically apply a location tag to each selected item, and store each location tag of each selected item within the store. One way that this may be accomplished is based on the alignment of the video with the store map supplied by the store. The store map includes locations of all SKUs within a store. The selection of the shelf tag will send, in a signal, the SKU selected to be in the cart. The server 14 may be programmed to compare the SKU with the SKUs on the store map, identify a location of the SKU within the store, and apply a location tag to the item in the virtual cart.

Additionally, in an embodiment, the customer shopping from home may enter a search for a product, much like online shopping, wherein when the search is executed, the user interface will display the shopping video or photography of the aisle and location within the aisle based on the product search or selected from the search results. Once in front of the portion of the aisle associated with the selected searched-for product, the system operates as described above to add the searched product to the virtual shopping cart.

In order to provide the customer with a more realistic shopping experience, the system 10 may operate to provide videos for customer engagements that the customer may experience during shopping in-person at the store. For example, and without limitation, FIG. 4C depicts a list of videos supplied by the server 14, wherein the videos have been sent to the server 14, for storage and access by customers, by the store that the customer is shopping at. These videos may be updated at predetermined times, such as, but not limited to, daily. For example, videos may comprise a Butcher Specials video, a Bakery Specials video, a Featured Items video, a Sample Booth video, a Today's Sandwich video, and the like, wherein the user interface on the user computing device 12 may depict buttons associated with each video such that selection of one of the buttons results in play of that particular video. For example, FIG. 4D depicts a Butcher Specials video that is played on the user computing device 12 in response to the selection of that video by the customer using the user computing device 12.

Once the customer has completed his or her shopping experience, the customer may select to end the shopping experience and send a signal to the server 14 to initiate fulfillment of the order of the selected items in the customer's virtual shopping cart. The server 14 may then operate with a shopper computing device 13 to initiate fulfillment of the customer order and communicate, with the shopper computing device 13, information necessary to fulfill the order of the customer.

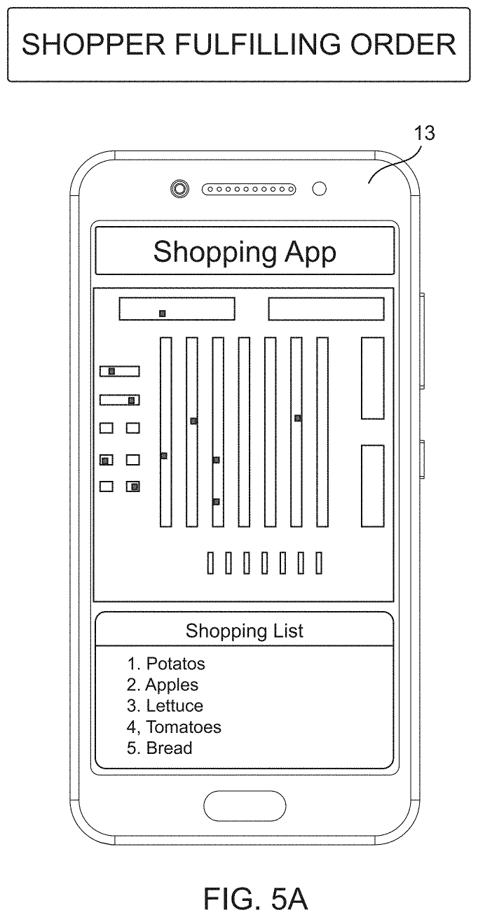

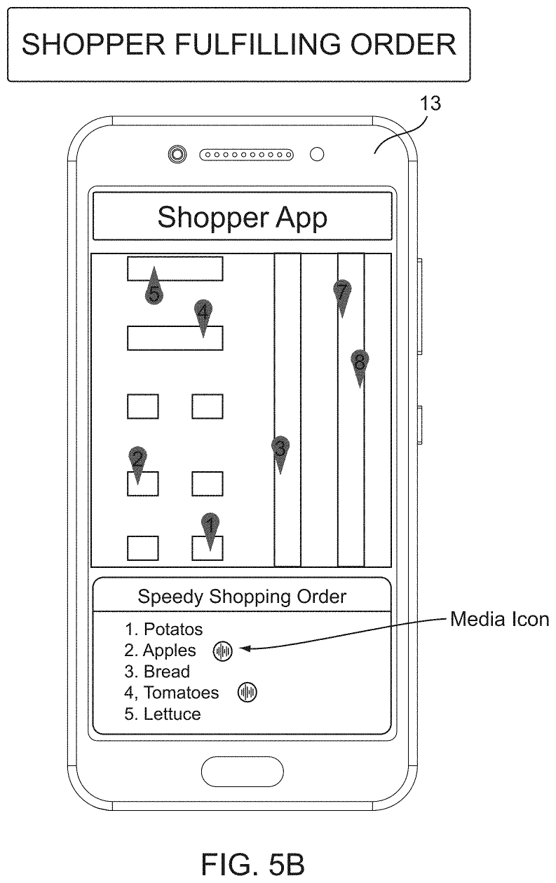

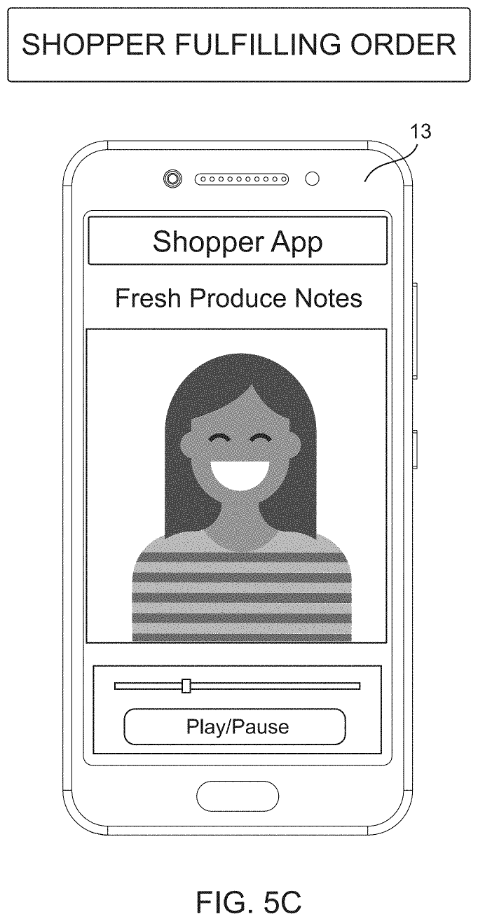

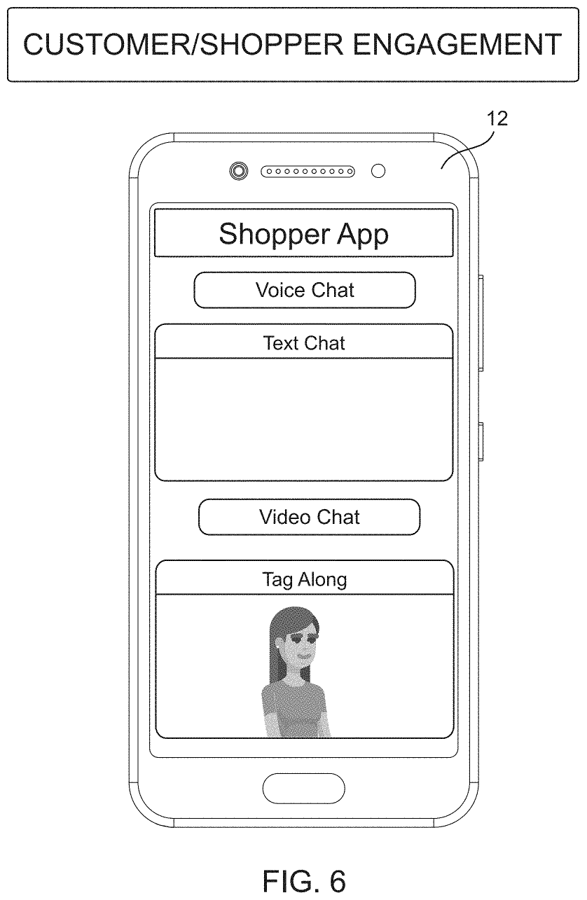

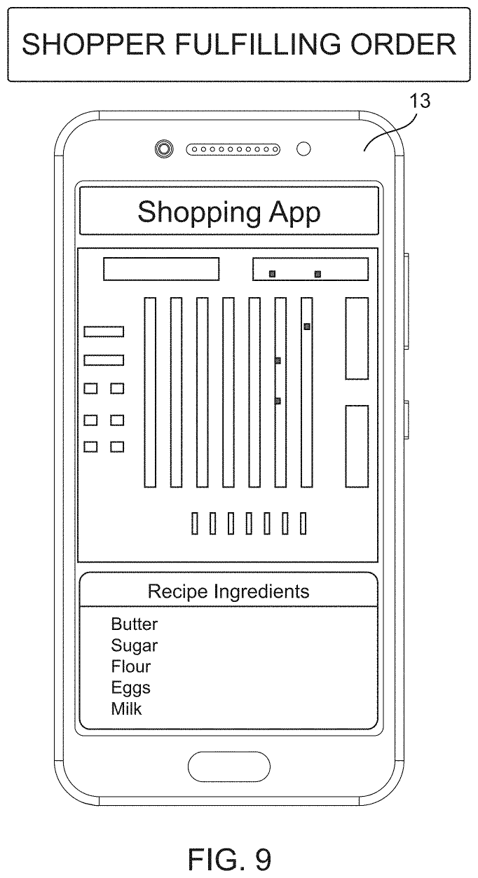

Referring to FIGS. 5A-9, the system 10 may then allow a fulfillment shopper to access the system through the shopper computing device 13 to engage in fulfillment, at the store, of a virtual remote order by the customer operating the user computing device 12. The fulfillment shopper using the shopper computing device 13 may access the system and server 14 may display a user interface that may include a shopping list and a map with location designators associated with the location tags for each item within the shopping list, as shown in FIG. 5A. In some embodiments, the list may be a recipe list that is auto-populated when a customer selects to make a certain food item, as shown in FIG. 9. The fulfillment shopper may easily see the items and the locations of such items within a store. This increases efficiency by showing where each product is. This is particularly useful for a fulfillment shopper that has never been within the store he or she is shopping to fulfill the order of the customer. In embodiments, as shown in FIG. 5B, the user interface may allow the fulfillment shopper to zoom in on the map to better see the locations of the items. The system, also shown in FIG. 5B, may provide not just a shopping list, but a speedy shopping order, wherein the server 14 is programmed to determine the most efficient route and order of selecting items for the best efficiency for fulfillment of the order. The item numbers in the map may correspond to the item numbers in the list. This further increases efficiency by displaying the best travel route through the store to obtain all items to fulfill the order. Additionally, as depicted in FIG. 5B, the customer may have further information for items on the list and may record video or audio associated with one or more selected items in the shopping list, depicted as a media icon in FIG. 5B. The fulfillment shopper may select the media icon and get more information from the customer, such as, alternatives if the product is out, the selection criteria of produce or the like. For example, if the shopper selects the media icon by Apples shown in FIG. 5B, the shopping computing device 13 may be directed to a video user interface as depicted in FIG. 5C, wherein the customer has recorded a video explaining the type of apples she likes. The fulfillment shopper may have typical video controls.

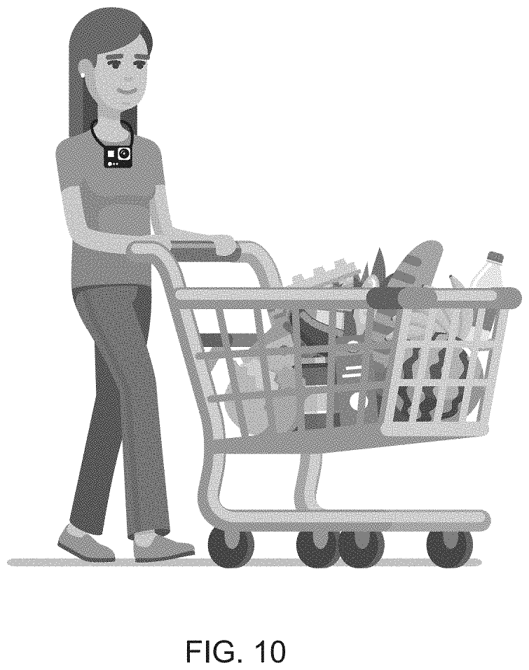

While fulfilling the order, the fulfillment shopper may have questions for, or otherwise have need to contact, the customer. The user interface may include a communication interface provided by the server 14 that allows the user computing device 12 to communicate with the shopper computing device 13 through voice chat, text chat, or video chat, thereby allowing the fulfillment shopper to communicate with the customer whose order is being fulfilled, including the customer providing additional items not on the list that the customer wishes to add. It is also contemplated that the application can be used for real-time remote shopping without a predetermined shopping list and the customer may direct the shopper in the store in real time through video chat. Further, the customer can select a tag along button and view video of the shopper during the fulfillment of the order by the fulfillment shopper at the store. This is further described with reference to FIG. 10.

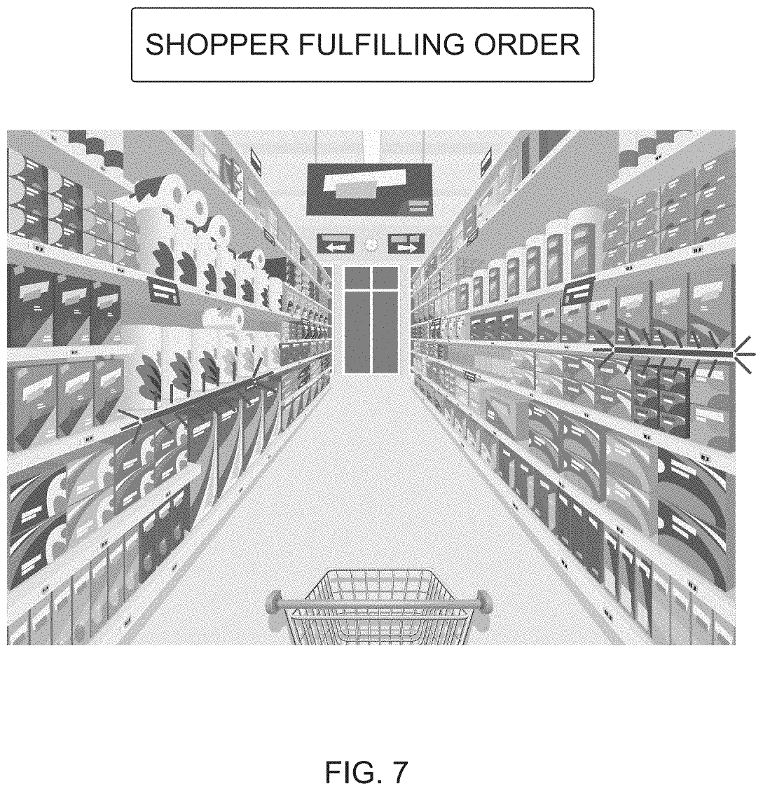

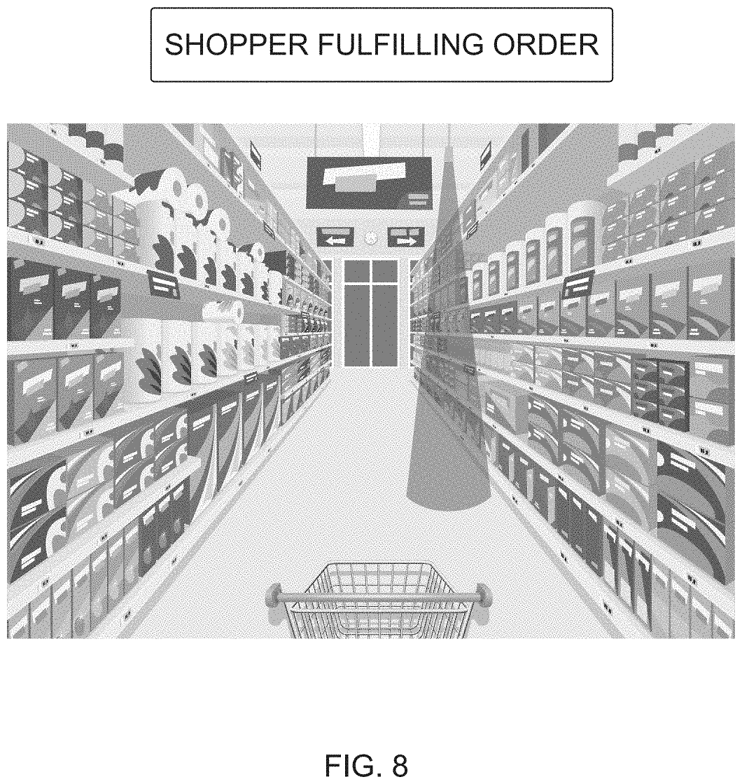

In some embodiments, stores may also be equipped with indicators that can help in efficiency improvement, wherein the indicators assist the fulfillment shopper with identifying where items in the shopping list are located. For example, as the fulfillment shopper enters the store, the fulfillment shopper may utilize the shopper computing device 13 to check into the store or otherwise notify the store that the fulfillment shopper is there, including providing the shopping list to a store computing system. The store computing system may also communicate with the server and receive the location tag and then set a predetermined color for the items in the shopping list of the fulfillment shopper, such as red or blue or any other color. FIG. 7 depicts lights on the shelves of aisles that may light up showing the locations of items on the shopping list. FIG. 7 depicts a scenario in which more than one fulfillment shopper is in the store with one light being red and another light being blue to distinguish between orders and fulfillment shoppers. FIG. 8 depicts another way of identifying, which may include a light that shines a particular color down on the aisle at a location of the item in the shopping list. This can work in conjunction with the map on the shopping user interface depicted on the shopper computing device 13.

In some embodiments, as shown in FIG. 10, the fulfillment shopper may utilize a camera, such as a body camera as depicted, or it may be a helmet camera or other camera system that can show the fulfillment shopper's perspective in the store. This camera may be in communication with the shopper computing device 13 and may be utilized to stream the shopping trip to the customer computing device 12. In these embodiments, the home customer can direct the in-store fulfillment shopper. Further, the home customer may see the cleanliness of the shopper and his or her shopping process, such as how the shopper performs his or her shopping, such as what the shopper is doing with his or her hands, what the food is touching, how the items are being treated, and so forth. This adds to the in-store shopping experience from a remote location and provides entertainment.

Embodiments may further include the following features: a camera system may survey each aisle at predetermined time intervals, such as every hour, every six hours, every day, and so forth; the at-home customer will know what is available because the video or photography of the aisles will be current, showing the actual products; the system can get smarter about your choices and make recommendations; the system may be utilized with custom stores that are set up to never have customers in the store, but just for this display system like a virtual grocery store; the system is scalable for a small number of SKUs to a large number of SKUs; the system can highlight what a customer bought last time on the video trail; and the like.

Embodiments may be available on or through the internet, such as through domain names reserved and owned by Applicant that include grocery-cam.com, mmgoodcam.com, homestorecam.com, myshoppingcam.com, aisledelight.com, fresh-run.com, fridgerun.com, basicsrun.com, virtualyfresh.com and the like.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire-line, optical fiber cable, RF, etc., or any suitable combination of the foregoing.

Computer program code for carrying out operations for aspects of the present invention may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, cloud-based infrastructure architecture, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims.

1. A shopping system comprising:
a server having a memory storing store information, comprising at least one shopping video or photography of travel up and down aisles of a store recorded by a camera system;
a shopper computing device coupled to the server; and
a user computing device coupled to the server, wherein the server is programmed to:
receive and process a signal from the camera system containing recorded shopping video or photography of travel up and down aisles of the store and store the shopping video or photography in the memory of the server;
receive and process a signal from the user computing device that the user computing device has accessed the system and requested to shop at the store;
send, for display on the user computing device, a shopping interface including the shopping video or photography with navigation controls;
receive navigation input from the navigation controls on the shopping interface displayed on the user computing device and adjust the display in response to the input from the navigation controls;
receive item selection inputs from the user computing device, store the selection inputs as items in a shopping list, and store each location of each selected item within the store;
receive a signal from the user computing device that the items in the shopping list are ready for fulfillment;
receive and process a signal from the shopper computing device that the shopper computing device has accessed the system and is available to fulfill the shopping list input by the user computing device; and
send, for display on the shopper computing device, a shopper interface including the shopping list and location of each item of the shopping list within the store.

2. The shopping system of claim 1, wherein the store information further comprises store maps.

3. The shopping system of claim 2, wherein the store maps are associated with the at least one shopping video or photography.

4. The shopping system of claim 1, wherein the shopper computing device is a mobile computing device.

5. The shopping system of claim 1, wherein the user computing device is a mobile computing device.

6. The shopping system of claim 1, wherein a communication interface is displayed on the user computing device for communication with the shopper computing device through voice chat, text chat, and/or video chat.

7. The shopping system of claim 1, wherein the camera system is a mobile system.

8. The shopping system of claim 7, wherein the camera system comprises a cart.

9. The shopping system of claim 8, wherein the cart is navigated up and down the aisles.

10. The shopping system of claim 9, wherein the cart comprises one or more mobile cameras.

11. The shopping system of claim 10, wherein the one or more mobile cameras are mounted to the cart such that the one or more mobile cameras are at shelf levels to record each shelf of the aisles.

12. The shopping system of claim 1, wherein the at least one shopping video or photography identifies what SKUs are located on what shelf.

13. The shopping system of claim 1, further comprising a shopper camera in communication with the shopper computing device.

14. The shopping system of claim 13, wherein the shopper camera streams a shopping trip through the store to the user computing device.

15. The shopping system of claim 1, wherein the at least one shopping video or photography are updated at predetermined times.

16. The shopping system of claim 15, wherein the at least one shopping video or photography are updated daily.

17. The shopping system of claim 1, further comprising more than one of the shopper computing device.

18. The shopping system of claim 1, further comprising more than one of the user computing device.
